(19) United States
(12) Patent Application Publication
(10) Pub. No.: US 2010/0089213 A1
(43) Pub. Date: Apr. 15, 2010

(54) Chopping Wheel

(76) Inventors: Dominique Font, St. Baldoph (FR); Michel Oudart, Chambery (FR)

Correspondence Address: OWENS CORNING, 2790 COLUMBUS ROAD, GRANVILLE, OH, 43023, US

(21) Appl. No.: 12/375,101

(22) PCT Filed: Jul. 23, 2007
(86) PCT No.: PCT/FR07/51708

§ 371 Date: Dec. 24, 2009

(30) Foreign Application Priority Data
Jul. 26, 2006 (FR) 0653122

(51) Int. Cl. B26D 1/36; B26D 7/18; B26D 1/40

(52) U.S. Cl. 83/117; 83/346

(57) ABSTRACT

Chopping wheel (19), intended for chopping continuous strands into sections of predetermined length, which has a backup component consisting of a rotating drum equipped with blades (22) arranged perpendicular to its periphery and, between these blades (22), components that, under the effect of the centrifugal force, are supposed to ensure the compression of strands (11) against the surface of a backup drum, and then the chopping of the strands into sections (14), and the ejection of the chopped sections, the components ensuring the compression of the strands consisting of fins connected to deformable ring (26, 27a, 27b) arranged under the base of blades (22) and whose axis coincides with the axis of rotation of said chopping wheel (19), is characterized by the fact that on each side, deformable ring (26, 27a, 27b) has a parallel straight side extending from the base of deformable ring (26, 27a, 27b) to the base of the fins.

The present invention relates to the domain of manufacturing of chopped strands made of high performance material, or stands made of thermoplastic material, glass strands in particular, and it relates more specifically to improvements made on a chopping wheel.

There are a number of known devices for carrying out such manufacturing operations. These systems generally include at least one die from which glass strands are drawn and brought to a chopping device most often consisting of a “chopping wheel” equipped with multiple blades whose relative spacing contributes towards chopping the fiber to the desired length and of a backup cutting wheel called an “anvil wheel” most often consisting of an elastomer banding over-molded or added onto a removable rim attached on the chopping machine. The continuous chopping of the fiber is obtained by high speed rotation of this set of wheels and the pressure of the chopping wheel on the anvil wheel by the intermediary of a suitable clamping means.

The glass strand chopping processes as of a few decades have become continuous processes in which the glass strands are chopped directly, leaving the die after drawing. These processes known as “direct” or “direct under the die” are high speed processes in which the chopping speed is compatible with the speed of drawing of the strands.

During the chopping process, the chopping wheel and the anvil wheel must ensure that: the chopping remains constant for the longest periods of time possible, the elements constituting the wheels must keep their integrity and not prejudice the safety of the personnel, the cost of the consumables must be as low as possible.

More particularly, it is then understood that the quality of the chopping of the fiber, in particular its density and its dynamic integrity, is directly connected to the ability of the materials that are present (constituting the blades and the backup wheel) to keep their characteristics (keep the geometric parameters of the blades, resistance to wear and tear by abrasion and to notching of the elastomer of the anvil wheel).

The first major difficulty to be solved in chopping under the die is the ability of the wheel to chop the glass fiber while drawing it at high speed without slipping.

The operation of drawing without slipping is difficult. In effect, after a chopping operation, the next blade (sometimes a distance of only 3 mm from the preceding one) presses on the glass fiber at the risk of chopping it and ruining it because the latter is pulled backward by the fiber forming tension.

Disregarding this limitation would lead to the production of chopped strands of random length less than the desired length.

Furthermore, at the time of chopping, the moist fibers are connected together only by capillary forces, and at the time of the impact exerted by the blade, this fragile structure could burst and lead to the production of a set of fibrils (ordinarily called “fins”).

Furthermore, after chopping, the chopped element has a tendency to become wedged between 2 consecutive blades by a jamming effect; in order to prevent elements from settling between the blades and leading to a generalized jamming of the system with each turn of the chopping wheel, it is necessary for a special device to exert an extracting force that ejects the chopped strand out of the blades just after the chopping zone.

There are known chopping wheels which have, on one hand, a backup component consisting of a rotating elastomer drum, and on the other hand, blades arranged perpendicularly to its periphery and, between the blades, components that, under the effect of the centrifugal force, are supposed to ensure the succession of the following steps: compression of the strand against the surface of a backup drum for its drawing, chopping of the strand and ejection of the chopped sections.

The components ensuring the compression of the strand consist of fins connected to a deformable ring, generally based on elastomer, for example, polyethylene, arranged under the base of the blades and whose axis coincides with the axis of rotation of the chopping wheel. These chopping wheels give satisfaction and meet the requirements mentioned in the preceding.

However, the inventors realized that by using wheels of this type for large production volumes of chopped sections and high speeds, it was very difficult or even impossible to obtain satisfactory results.

The inventors looked for the origin of the phenomenon that generates a limitation of the chopping speeds reached.

After analysis, it proved to be the case that an uncontrolled deformation of the blades, and more particularly a bending of the blades (all the more extensive when the chopping wheel is motorized and the number of dies is large), between their bearing point during the cycle of drawing, chopping, ejection of the chopped strands, was at the origin of the problem.

Even more precisely, under the effect of this bending of the blades, the blades have a tendency to shorten and to generate heating and then softening at the site of their bearing zone with clamping rings positioned on either side of the deformable ring, these rings exerting their clamping force on the inclined bearing surfaces of the blades. Under the effect of the softening of the clamping rings, lateral play is created at the site of the zone of clamping with the blades, which generally leads to their rupture.

The present invention proposes to contribute a solution to all of these limitations by proposing an improved chopping wheel technology that allows high chopping speeds and a larger number of dies.

To this effect, the chopping wheel intended for chopping continuous strands into sections of predetermined length, which has a backup component consisting of a rotating drum equipped with blades arranged perpendicularly to its periphery and, between these blades, components that, under the effect of the centrifugal force, are supposed to ensure the compression of the strands against the surface of a backup drum, and then the chopping of the strands into sections, and the ejection of the chopped sections, the components ensuring the compression of the strands consisting of fins connected to a deformable ring arranged under the base of the blades and whose axis coincides with the axis of rotation of said chopping wheel, is characterized by the fact that on each side, the deformable ring has a parallel straight side extending from the base of the deformable ring to the base of the fins.

Thanks to the use of a deformable ring with straight sides extending over the whole diameter, it is possible, with the immobilization of the blades by clamping rings, to induce clamping forces strictly normal to the lateral walls of the deformable ring, which forces thus, during high speed rotation of the chopping wheel, do not bring about a deformation of the clamping rings on their zone of contact with the blades. The deformable ring eliminates bending of the blades and therefore their deterioration. The straight sides of the deformable ring prevent it from melting by the fact that all the forces are distributed over a greater bearing surface.

In some preferred embodiments of the invention, one and/or another of the following arrangements moreover can possibly be used: the deformable component is at least in the form of two parts and a spacer separating the two parts, and is mounted concentrically with respect to the axis of rotation of the drum, the spacer serving as bearing point for said blades between their two ends, the blades are, on one hand, immobilized at the site of their ends, and on the other hand, rest at the site of at least one point situated between its [sic] ends, the ends of the blades are inserted in slots made in two collars mounted face to face, concentrically with respect to the axis of rotation of the drum, the ends of the blades are maintained at the bottom of the slots made in the collars by means of a pair of elastomer rings and a pair of end plates, said end plates being suitable for inducing clamping forces at the site of the elastomer rings, the end plates and the elastomer rings are mounted face to face, concentrically with respect to the axis of rotation of the drum, all or some of the pieces chosen from the end plates, the elastomer rings, and the collars, are symmetrical pieces, the deformable component entails a ring provided at its periphery with a number of fins, the fins and the ring forming a monolithic unit, the fins and the ring are produced out of different materials, a space is arranged between 2 contiguous fins and is delimited by the connection surface between the base of the fins and the base of a blade, during operation, the upper surface of the fins describes a cylindrical surface generated by revolution whose radius is different from that of the circle passing through the summit of the cutting edge of the blades, the difference between the two radii is a few tenths of a millimeter.

According to another aspect of the invention, it also relates to a chopping machine intended for the manufacturing of chopped strands for technical use, in particular strands made of thermoplastic material and particularly glass strands, said machine having a three-dimensional frame having three or more sides and at least one chopping unit connected to one of the sides of said frame, said chopping unit using a chopping wheel as described in the preceding as well as an anvil wheel.

Other characteristics and advantages of the invention will appear in the course of the following description of a number of its forms of execution given as non-limiting examples.

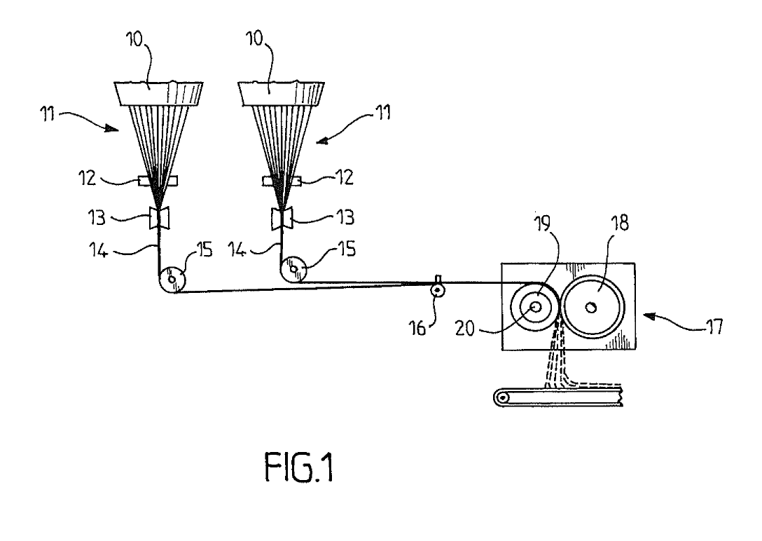

FIG. 1 is a diagrammatic view of the general installation of the device and of the equipment associated with it for drawing continuous glass filaments from multiple sources,

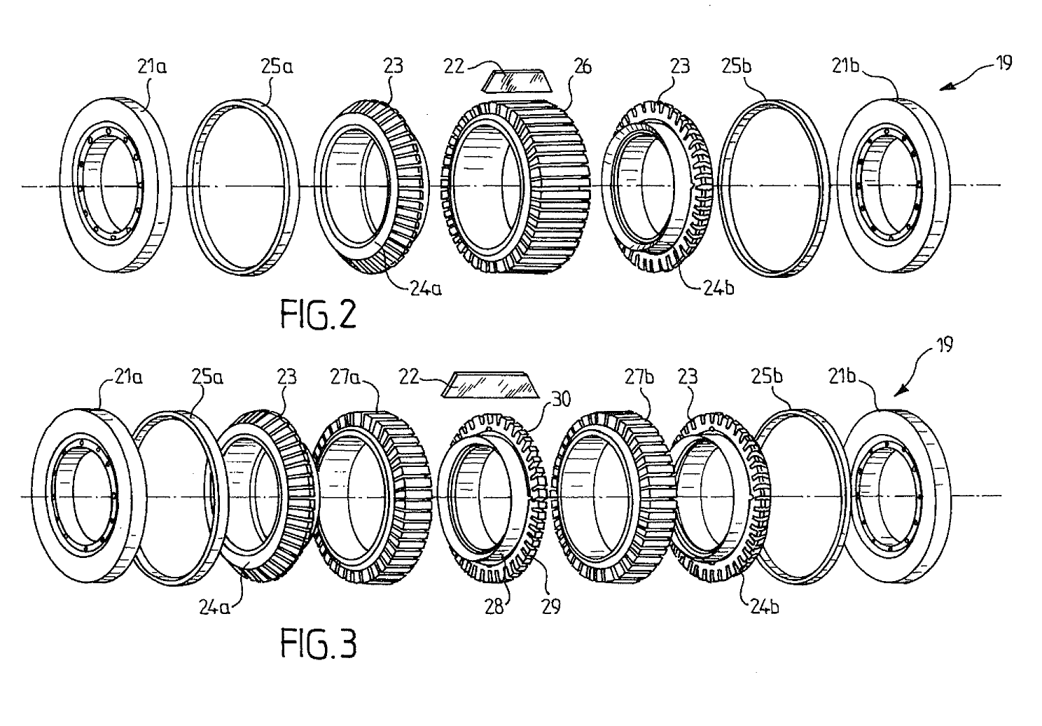

FIG. 2 is a diagrammatic view in perspective of the different pieces constituting the chopping wheel according to a first embodiment,

FIG. 3 is a diagrammatic view in perspective of the different pieces constituting the chopping wheel according to a second embodiment,

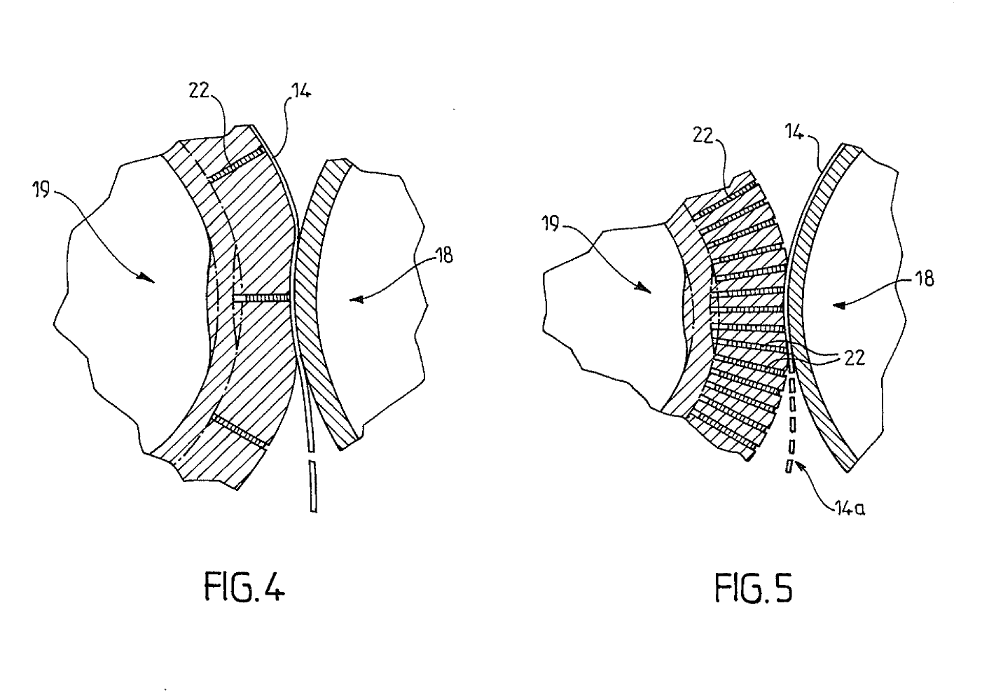

FIGS. 4 and 5 are views in partial diagrammatic section of a chopping wheel and of an anvil wheel according to various chopping length configurations.

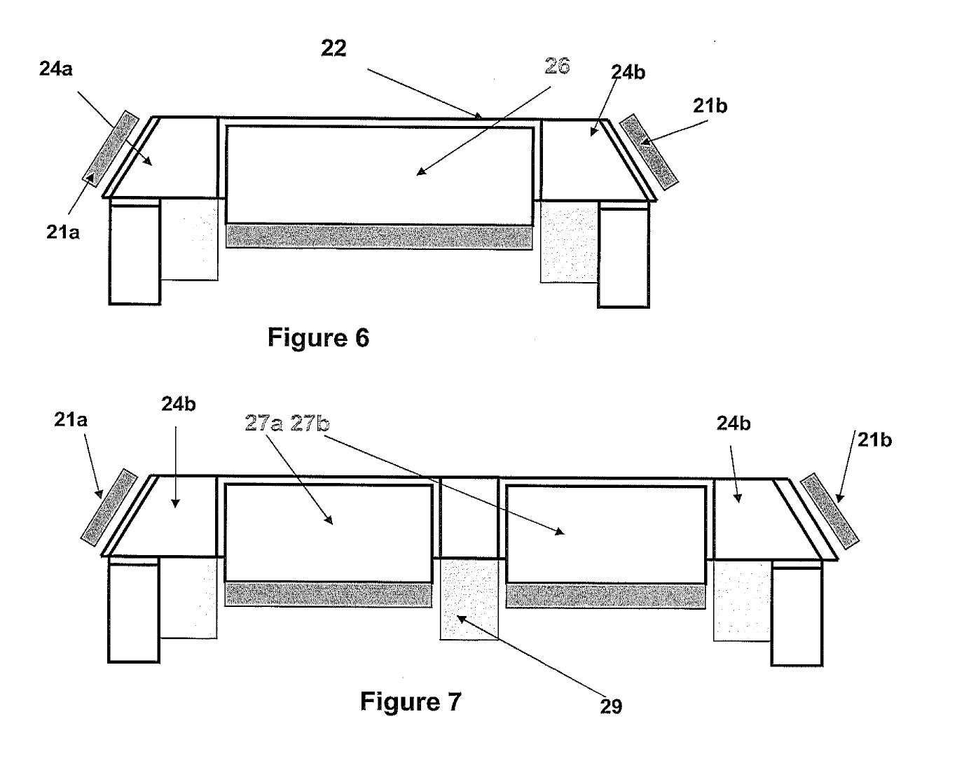

FIGS. 6 and 7 are diagrammatic views of the embodiments illustrated in FIGS. 2 and 3.

The manufacturing line, diagrammed by FIG. 1, includes upstream at least one die 10 fed using melted glass or glass balls by a feed device that is not represented. Die(s) 10, generally made of platinum and rhodium alloy and heated by Joule effect, are provided at their lower part with a number of openings from which a number of filaments 11 are mechanically drawn. These filaments forming at least one sheet are coated with a lubricating sizing product, ordinarily called sizing, by passage over coating device 12, before being joined in the form of strands by assembling rollers 13. Strands 14 thus formed are brought by deflecting pulleys 15 to guiding device 16, for example, a comb, before being introduced into chopping machine 17 composed of backup drum 18 (ordinarily called anvil wheel) and of a blade carrying drum, ordinarily called chopping wheel 19.

According to FIG. 1, the drawing is obtained just by the action of the chopping device whose operation will be described further on; it could be brought about by an auxiliary drawing device placed upstream from the chopping device, such as those described in U.S. Pat. No. 3,873,290.

The chopping device according to the invention can be arranged in different ways; its arrangement will depend on the means used upstream for guiding and drawing the strands, as well as on the installation of the device for receiving the chopped strands. Thus, for example, FIG. 1 represents a conventional arrangement making it possible to project the chopped strands vertically.

The structure of chopping wheel 19 according to 2 distinct embodiments is represented by FIGS. 2 and 3.

Chopping wheel 19 has hub 20 (which can be seen in FIG. 1) and clamping end plates 21a, 21b containing the different elements for attachment of chopping blades 22.

Chopping blades 22, which have a taper at each end, are inserted by these tapers into radial slots 23 of collars 24a and 24b. Collars 24a and 24b are mounted concentrically on hub 22 [sic; 20]. The collars are mounted concentrically with respect to the axis of rotation of chopping wheel 19 by bearing surfaces and are clamped against one another between clamping end plates 21a, 21b, the whole being connected by locking components (screws, for example).

Flexible rings 25a, 25b made of elastomer are arranged between clamping end plates 21a, 21b and the sides of collars 24a, 24b resting on the tapered faces of the chopping blades.

With the clamping of end plates 21a, 21b on hub 22 by the intermediary of screws, elastomer rings 25a, 25b are compressed and consequently maintain the blades at the bottom of radial slots 23 made in collars 24a, 24b.

The depth of grooves 23 is greater than the height of the blades. Collars 24a and 24b are made of steel, and they make it possible to keep the blades spaced apart. In contrast, clamping end plates 21a, 21b are made of steel and undergo a thermal treatment (addition of chromium) and serve as support for the bottom of the blades. (In case of wear and tear, it is easier and more economical to recondition end plates 21a, 21b rather than collars 24a, 24b.)

Furthermore, under and between the blades is deformable component 26, 27a, 27b preferably made of elastomer.

In the variant executed in FIGS. 2 and 6, chopping wheel 19 has a single deformable component 26 trapped between clamping end plates 21a, 21b.

In contrast, FIGS. 3 and 7 pertain to chopping wheel 19, a so-called wide wheel, which is designed particularly for large production volumes of chopped strand sections. This chopping wheel overall incorporates the components of the preceding chopping wheel and differs from it by the addition of second deformable component 27b (in fact, deformable component 26 has been separated into 2 parts 27a and 27b so that support collar 29 can be positioned) juxtaposed with first deformable component 27a, the two deformable components 27a, 27b being separated axially by spacer 28 giving blades 22 a bearing point essentially equidistant from their ends. Central collar 29 positioned coaxially with respect to spacer 28 is provided on its periphery with a number of radial slots 30 for the passage of chopping blades 22.

Deformable component 26 (or multiple deformable components 27a, 27b in the case of FIG. 3) situated under blades 22 consists of an elastomer ring whose edges are erected over the whole diameter in such a way as to offer a planar bearing surface so as to adopt the exact shape of the cylindrical bearing surfaces of the collars.

Deformable components 26, 27a, 27b are connected to the ring forming the central part and project from its upper surface in the form of fins arranged with the same spacing as blades 22 and become lodged, with a certain amount of play, in the free spaces between said blades. These components thus form a collar with deformable fins, which is preferably monolithic; this collar, mounted free without clamping, is angularly positioned and is kept centered in a non-rigid manner by the intermediary of collars 24a, 24b.

It can be observed that during operation, the upper surface of the fins describes a cylindrical surface generated by revolution whose radius is different from that of the circle passing through the summit of the cutting edge of the blades, and the difference between the two radii is a few tenths of a millimeter.

It results from the embodiment described in the preceding that blades 22 are maintained at their ends, by the intermediary of flexible contacts, against the rigid contacts formed by the bottom of radial slots 23 of collars 24a, 24b and at least situated between the ends, this point resting on the holder of central collar 29 (in the execution example represented in FIG. 2, the central bearing point does not exist). Chopping wheel 19 thus assembled is mounted on rotating hub 20 represented in FIG. 1, and is centered on it by the intermediary of a cone; the attachment of the chopping wheel on the shaft is ensured by screws.

The axis of rotation of the finned collar then coincides with that of the chopping wheel.

Annular deformable components 26, 27a, 27b and its [sic; their] fins are made of elastomer, for example, of polyurethane whose Shore hardness, A scale, is between 80 and 100. It is also possible to conceive of a two-material execution, the core of the component made of a first plastic with over-molding of a second plastic material forming the fins, with it possible for the first and second plastic materials to have different mechanical properties, particularly in terms of hardness.

As emerges from FIG. 1, chopping wheel 19 cooperates with anvil wheel 18. The surface of the latter is covered with a flexible layer made of elastomer, for example, of polyurethane identical to that constituting the finned collar described in the preceding.

The distance separating the axes of rotation of drums 18 and 19 is adjusted (by applying a clamping pressure) so that the cutting edge of the blades does not penetrate very deeply into the covering of the backup drum (the deformation of the elastomer layer limits the penetration of the blades).

It will be noted that the diameter of the finned collar is such that when the chopping device is stopped, the upper surfaces of the fins do not stick out past the level of the cutting edge of the blades. The driving movement is preferably given to chopping wheel 19, which sets anvil wheel 18 mounted free on its axis in motion. The movement is simultaneously transmitted by the action of the fins on the covering and by the engagement resulting from the slight penetration of the blades into said covering.

It can also be noted that the thickness of the annular part of deformable component 26, 27a, 27b is determined as a function of the Young's modulus of the elastomer material constituting said component, so that there is a correct expansion of the fin (which serves as bearing point with the strands during the drawing phase, and then during the phase of chopping into chopped strand sections) for the desired cutting speed ranges.

FIG. 4 represents the operation of the device according to the invention suited to the manufacturing of relatively long chopped strands.

According to this figure, chopping wheel 19 has a collar with fins whose upper surfaces come to the level of the cutting edge of the blades when the chopping wheel is stopped. When the chopping wheel reaches its normal speed of rotation, the deformable component and the fins have undergone a slight radial expansion caused by the centrifugal force, and under this effect, the succession of the upper surfaces of the fins then forms a quasi continuous cylindrical surface generated by revolution whose radius is greater than that of the concentric circle passing through the summit of the cutting edge of the blades. In this case, the cylindrical surface generated by revolution and that of the covering come in contact, and by this action alone grip the strand or strands and bring about their drawing before they are chopped. The pressure exerted by the fin on the glass strand is independent of the clamping pressure exerted between the axes of the 2 wheels (chopping wheel and anvil wheel). This pressure is constant and is only a function of the nature and geometry of the deformable component.

Chopping wheel 19 also has blades whose spacing is such that the chopping work is done by a single blade at a time.

In the actual chopping zone, the fins are pushed back inward under the effect of the pressure exerted by the surface of anvil wheel 18; under this action, the annular part of the deformable component is radially deformed inward in the space situated over the collar holder.

This results in gradual disengagement of the cutting edge of a blade that, penetrating into the peripheral covering of the anvil wheel, then chops the strand and gives rise to the strand piece.

Leaving the chopping zone, the latter is ejected by the fins that gradually come back out under the action of the centrifugal force.

In this variant, the rotation of the anvil wheel by the driving chopping wheel is ensured essentially by the close cooperation of the cylindrical surface generated by revolution and that of the covering; this results in a compression of the chopped strand piece, which is attenuated by the radial contraction of the finned collar and is not sufficient to damage its integrity.

FIG. 5 represents the operation of another variant of the device according to the invention suited to the chopping of a strand into sections of short length, for which the spacing of the blades is such that the chopping work is done simultaneously by at least two blades.

The integrity of the chopped strand pieces becomes all the more difficult to maintain as the number of points of contact between the different elementary filaments forming the strand piece decreases, which is the case in particular when the length of the strand pieces is reduced. The loss of cohesion can occur either due to crushing of the strand piece between two surfaces strongly pressed against one another or due to shearing occurring during the chopping of a strand piece that is insufficiently maintained during this operation.

It is therefore necessary either to avoid excessive clamping between the upper surface of the fins and the surface of the covering of the anvil wheel or in contrast to avoid an absence of contact between these two surfaces, the extreme cases in which a certain number of elementary filaments separate from the chopped strand pieces, leading to the formation of fluff and rapid fouling of the device.

The method of operation of the chopping system illustrated in FIG. 5 is the following: the strands are moved just by the traction resulting from their adherence on the surface of the covering of the anvil wheel. In the actual chopping zone, the strands come in contact with the cutting edge of a first blade and are then trapped and held between the surface of the covering, the upper surface of a fin and the next blade that initiates the sectioning of the strand piece. In contact with the covering, the fins are pushed back but to a lesser extent and under less pressure than in the preceding case. The chopped strand piece is thus simply maintained clamped between the two elastomer surfaces and completely keeps its integrity.

Leaving the chopping zone, the fins come back out and eject the chopped strand pieces. In this variant, the rotation of the anvil wheel by driving chopping wheel 19 is ensured essentially by the penetration of the blades into the covering of the anvil wheel. For this reason, it can also be advantageous to use a chopping wheel provided with blades arranged perpendicularly to its periphery and inclined with respect to its axis of rotation by an angle between 10 and 30°.

It emerges from the preceding description that the chopping device is adjusted in such a way that the chopping blades do not penetrate very deeply into the covering of the anvil wheel, this adjustment being corrected whenever the deterioration of the surface of said covering requires re-machining. The deformable component is chosen in such a way that even after radial expansion caused by the centrifugal force, the upper surfaces of the fins describe a circle whose radius is slightly smaller than that of the circle passing through the summit of the cutting edge of the blades. In operation, a difference of 5/10 mm has been measured.

As a function of this adjustment, the characteristics of the deformable component(s), and mainly the difference between the radii of the concentric circles described by the upper surfaces of the fins and the summit of the cutting edge of the blades, will be chosen particularly in accordance with the desired length of the chopped strand pieces.

This difference is on the order of a few tenths of a millimeter, for example, − 2/10 to + 3/10 of a millimeter considering as reference radius that of the circle passing through the summit of the chopping blades.

Besides the length of the chopped strand pieces, it is quite obvious that other parameters, such as, for example, the moisture content of the strand or the diameter of the filaments constituting said strand, will also have to be considered in order to choose the finned collar best suited to the envisaged manufacturing.

The device according to the invention combines numerous advantages including the following in particular: The possibility of bringing about the chopping of a number of glass strands drawn from a number of dies at linear drawing speeds of several tens of msec. The deformable component with fins makes it possible to maintain the integrity of the strand sections and to eject them out of the chopping zone. The deformable component with fins makes it possible to prevent fouling of the chopping wheel. The chopping wheel that is driving and keeps a constant diameter avoids changes in adjustment of the speed of rotation.

The chopping wheel is easy to mount and to remove when it becomes necessary to change one or more blades. Most pieces constituting it are symmetrical, which facilitates assembly and reduces the number of pieces in stock.

The structure of the chopping wheel also has the advantage that it is possible to modify the length of the strand sections by a quantity that is a multiple of the spacing of the grooves. (It is possible to alternate non-cutting blades between the chopping blades in order to vary the cutting spacing). In effect, for a given deformable component with fins, the adjustment of the length can be obtained easily by inserting between two successive chopping blades one or more blades without cutting edges and whose height is such that they do not touch the surface of the backup drum in the chopping zone. The purpose of the insertion of these blades is to keep the deformable component with fins in place and to avoid extensive deformations that would bring about its rupture.

At the limit, it is possible to equip the blade holding drum with a single chopping blade and thus to obtain sections whose length is equal to the circumference of said drum.

More commonly, sections whose length can vary between 3 mm and approximately 50 mm are obtained without difficulty from strands drawn at speeds between 30 and 50 m/sec.

1-13. (canceled)

14. A chopping wheel for chopping continuous strands into sections of predetermined length, comprising:
a rotating drum having a rotational axis and an outer periphery;
a backup drum in contact with the outer periphery of the primary drum;
a plurality of blades within the primary drum and arranged perpendicularly to the periphery;
a deformable insert within the rotating drum and sharing a rotational axis with the rotational axis of the rotating drum; and
a plurality of fins connected to the deformable insert, arranged under the base of blades, the deformable insert having a parallel straight side extending from the base of deformable ring to the base of the fins;
whereby continuous strands are compressed between the plurality of blades and the surface of backup drum, chopping of the strands into sections, and ejecting the chopped sections.

15. The chopping wheel of claim 14, wherein the deformable insert further comprises:
a spacer mounted concentrically with the axis of rotation of the rotating drum, the spacer serving as bearing point for the blades along their length.

16. The chopping wheel of claim 14, wherein the blades have distal ends which are fixed, and on the other hand, rest at the site of at least one point situated between their ends.

17. The chopping wheel of claim 16, further comprising:
two collars mounted adjacent the deformable insert each collar having a plurality of slots formed therein for receiving the ends of blades.

18. The chopping wheel of claim 17, further comprising:
elastomer rings over the distal ends of the blades; and
end plates clamping the elastomer rings to retain the blades in the plurality of slots formed in the collars.

19. The chopping wheel of claim 18, wherein the end plates are mounted concentrically with respect to the axis of rotation of the drum.

20. The chopping wheel of claim 18, wherein the end plates are symmetrical pieces.

21. The chopping wheel of claim 14, wherein the plurality of fins and the deformable insert are a monolithic unit.

22. The chopping wheel of claim 14, wherein the fins and the ring are produced of different materials.

23. The chopping wheel of claim 14, wherein the space between two contiguous fins and is defined by a connection surface between the base of the fins and the base of a blade.

24. The chopping wheel of claim 14, wherein radius of the deformable insert and the radius of the cutting blades is different.

25. The chopping wheel of claim 24, wherein the difference between the two radii is a less than one millimeter.

26. A chopping machine, comprising:
a three-dimensional frame;
at least one chopping unit connected to the frame; and
a chopping wheel, having:
a rotating drum having a rotational axis and an outer periphery;
a backup drum in contact with the outer periphery of the primary drum;
a plurality of blades within the primary drum and arranged perpendicularly to the periphery;
a deformable insert within the rotating drum and sharing a rotational axis with the rotational axis of the rotating drum; and
a plurality of fins connected to the deformable insert, arranged under the base of blades, the deformable insert having a parallel straight side extending from the base of deformable ring to the base of the fins;
whereby continuous strands are compressed between the plurality of blades and the surface of backup drum, chopping of the strands into sections, and ejecting the chopped sections.

27. The chopping machine of claim 26, wherein the deformable insert further comprises:
a spacer mounted concentrically with the axis of rotation of the rotating drum, the spacer serving as bearing point for the blades along their length.

28. The chopping machine of claim 26, wherein the blades have distal ends which are fixed, and on the other hand, rest at the site of at least one point situated between their ends.

29. The chopping machine of claim 28, further comprising:
two collars mounted adjacent the deformable insert each collar having a plurality of slots formed therein for receiving the ends of blades.

30. The chopping machine of claim 29, further comprising:
elastomer rings over the distal ends of the blades; and
end plates clamping the elastomer rings to retain the blades in the plurality of slots formed in the collars.

31. The chopping machine of claim 30, wherein the end plates are mounted concentrically with respect to the axis of rotation of the drum.

32. The chopping machine of claim 26, wherein the plurality of fins and the deformable insert are a monolithic unit.

33. The chopping machine of claim 26, wherein the fins and the ring are produced of different materials.
